(19) United States
(12) Patent Application Publication
(10) Pub. No.: US 2025/0245261 A1
(43) Pub. Date: Jul. 31, 2025

(54) OBJECT MATERIAL GENERATION METHOD, SYSTEM, MODEL FINE-TUNING METHOD, AND ELECTRONIC DEVICE

(71) Applicant: Hangzhou Alibaba International Internet Industry Co., Ltd., Hangzhou (CN)

(72) Inventor: Shuaishuai ZHAO, Hangzhou (CN)

(21) Appl. No.: 19/022,698

(22) Filed: Jan. 15, 2025

(30) Foreign Application Priority Data
Jan. 30, 2024 (CN) 202410132688.2

(51) Int. Cl. G06F 16/383; G06F 16/332; G06F 16/3329

(52) U.S. Cl. CPC G06F 16/383; G06F 16/3326; G06F 16/33295

(57) ABSTRACT

Embodiments of the present application provide an object material generation method, system, model fine-tuning method, electronic device, and storage medium. The object material generation method includes: performing intent recognition on instruction information indicating the generation of an object material to obtain an intent recognition result, wherein the intent recognition result includes a material generation scenario and/or key information of the object; in response to the intent recognition result meeting a preset condition, formatting a preset prompt template based on the intent recognition result to generate a prompt; in response to the intent recognition result not meeting the preset conditions, generating a prompt based on the instruction information using a pre-fine-tuned prompt generation model; triggering a preset object material generation model based on the generated prompt to produce the object material.

### CROSS-REFERENCE TO RELATED APPLICATIONS

This application claims priority to Chinese Patent Application No. 202410132688.2, filed with the China National Intellectual Property Administration on Jan. 30, 2024, and entitled “Object Material Generation Method, System, Model Fine-Tuning Method, and Electronic Device,” which is incorporated herein by reference in its entirety.

### TECHNICAL FIELD

This application relates to the field of computer technology, specifically to an object material generation method, an object material generation system, a model fine-tuning method, an electronic device, and a storage medium.

### BACKGROUND

In e-commerce scenarios, product materials include, but are not limited to, text, video, and images. Product materials are often used to display products within or outside the platform, aiming to convey product information to users. Taking text-based materials as an example, such materials typically include information such as product names and product descriptions. The content presented in text materials significantly impacts the browsing experience for users. As the application scenarios evolve, the content of product materials requires continuous adjustment and optimization, posing substantial challenges for generating product materials. Particularly in scenarios where product materials are manually crafted, meeting the ever-changing demands for product content is labor-intensive and results in low efficiency in generating materials, which in turn leads to untimely updates of product materials.

With the development and maturation of large language models (LLMs), some scenarios have adopted solutions for automatically generating text materials. In scenarios where LLMs are used to generate text materials, it is typically necessary to fine-tune a pre-trained LLM using scenario-specific data, and then employ the fine-tuned model to generate product materials tailored to the specific scenario. However, in e-commerce settings, application requirements are continuously evolving, and relying solely on a fixed dataset to fine-tune an LLM model fails to meet the demands of rapid iteration in such applications.

It is evident that existing methods for generating materials for objects, such as products, still require improvements.

### SUMMARY

Embodiments of the present application provide an object material generation method that can enhance the efficiency and adaptability of generating object materials on e-commerce platforms.

Accordingly, embodiments of the present application also provide an object material generation system, a model fine-tuning method, an electronic device, and a storage medium to ensure the implementation and application of the aforementioned object material generation method.

To address the issues described above, this application discloses an object material generation method, which includes the following steps:
performing intent recognition on instruction information indicating the generation of an object material to obtain an intent recognition result, wherein the intent recognition result includes a material generation scenario and/or key information of the object;
in response to the intent recognition result meeting a preset condition, formatting a preset prompt template based on the intent recognition result to generate a prompt;
in response to the intent recognition result does not meet the preset condition, generating a prompt based on the instruction information using a pre-fine-tuned prompt generation model;
triggering a preset object material generation model based on the generated prompt to produce the object material.

To implement the above method, embodiments of this application also provide an object material generation system, which includes:
a client and a server, where:
the client is configured to obtain instruction information input by a user that indicates the generation of object materials and to send this instruction information to the server;
the server is configured to perform intent recognition on the instruction information to obtain an intent recognition result, wherein the intent recognition result includes a material generation scenario and/or key information of the object;
the server is further configured to, if the intent recognition result meets preset conditions, format a preset prompt template based on the intent recognition result to generate a prompt; or,
the server is further configured to, if the intent recognition result does not meet the preset conditions, generate a prompt based on the instruction information using a pre-fine-tuned prompt generation model;
the server is further configured to trigger a preset object material generation model based on the generated prompt to produce the object material and send the object material to the client;
the client is further configured to display the generated object material to the user.

To address the aforementioned issues, this application discloses a model fine-tuning method, which includes the following steps:
obtaining a set of first instruction information samples, wherein each of the first instruction information samples is used to indicate generation of an object material;
assigning labeling information to each first instruction information sample in the set, wherein the labeling information includes the material generation scenario and the key information of the object contained in the first instruction information sample, and wherein the material generation scenario includes any of the following: title generation, selling point generation, object detail generation, and marketing text generation, and the key information of the object includes an original title of the object, an object category, and an object attribute;
fine-tuning a pre-trained generative model using input-output text pairs composed of the first instruction information samples and the corresponding labeling information to obtain an intent recognition model.

This application also discloses a model fine-tuning method, which includes the following steps:
obtaining a first prompt sample and a corresponding first object material sample for the first prompt sample;
expanding the first prompt sample in dimensions of preset instruction information based on the first object material sample to obtain a second prompt sample;
obtaining a second object material sample corresponding to the second prompt sample using a preset question-answering language model;
fine-tuning a pre-trained large language model based on the first prompt sample and its corresponding first object material sample, as well as the second prompt sample and its corresponding second object material sample, to obtain an object material generation model.

This application further discloses an electronic device, comprising a processor and a memory communicatively connected to the processor. The memory stores computer-executable instructions, and the processor executes these instructions stored in the memory to implement the method as described in the embodiments of the present application.

This application also discloses a computer-readable storage medium, in which computer-executable instructions are stored. When executed by a processor, these instructions implement the method as described in the embodiments of the present application.

Compared with the prior art, the embodiments of the present application offer the following advantages:
by performing intent recognition on instruction information that indicates the generation of object materials, key information required to generate object materials is extracted from the instruction information to obtain an intent recognition result. Then, based on the specific conditions of the extracted information, an appropriate approach is used to generate a prompt that aligns with the input requirements of a prompt generation model fine-tuned with scenario data. The generated prompt is then used as the input to trigger the object material generation model to produce the required object material. This approach eliminates the need for separate fine-tuning of models based on data from each scenario, enabling the generation of object materials for preset scenarios based on any user-input instruction information. This improves both the efficiency and adaptability of object material generation.

### BRIEF DESCRIPTION OF THE DRAWINGS

FIG. 1 is a step flowchart of an embodiment of an object material generation method disclosed in this application.

FIG. 2 is another step flowchart of an embodiment of an object material generation method disclosed in this application.

FIG. 3 is a step flowchart of an intent recognition model fine-tuning method disclosed in this application.

FIG. 4 is a step flowchart of a prompt generation model fine-tuning method disclosed in this application.

FIG. 5 is a step flowchart of an object material generation model fine-tuning method disclosed in this application.

FIG. 6 is an additional step flowchart of an object material generation model fine-tuning method disclosed in this application.

FIG. 7 is a schematic structural diagram of an exemplary device provided in an embodiment of this application.

### DETAIL DESCRIPTION OF THE EMBODIMENTS

To make the objectives, features, and advantages of this application more apparent and easier to understand, this application is further explained in detail below with reference to the accompanying drawings and specific embodiments.

The object material generation method disclosed in the embodiments of the present application can be applied to generate text materials for various types of objects, wherein the objects include, but are not limited to, any of the following: products in e-commerce scenarios, search objects in search scenarios, and recommended objects in recommendation scenarios. In the embodiments of the present application, the object material generation method is illustrated using the example of a product in an e-commerce scenario, demonstrating the generation process of product materials.

Taking the cross-border e-commerce scenario within e-commerce as an example, product material requirements are diverse and constantly changing. For instance, in generating product selling points, different users have varying needs regarding the number, length, and language of the generated selling points. In current technologies, large language models (LLMs) fine-tuned on scenario-specific data can generate product materials; however, these solutions can only produce product materials tailored to fixed requirements and place stringent demands on the user's input instructions. For example, existing methods for generating product materials often exhibit significant deviations when handling unstructured or non-standard user instructions. Furthermore, in the case of LLMs fine-tuned on English scenario data, there is a noticeable decline in quality when generating product materials in other languages.

The object material generation method disclosed in this application's embodiments first assesses the clarity of intent expressed in the user's input instruction information. Based on this assessment, an appropriate approach is used to generate a prompt that both meets the input text requirements of the pre-fine-tuned object material generation model and fully conveys the user's requirements for the object material. The generated prompt then triggers the object material generation model to produce the desired object material. This method enables the generation of object material in response to any user input instruction, to obtain object material that aligns closely with the user's needs.

The following provides an illustrative example of a specific embodiment of the object material generation method disclosed in this application.

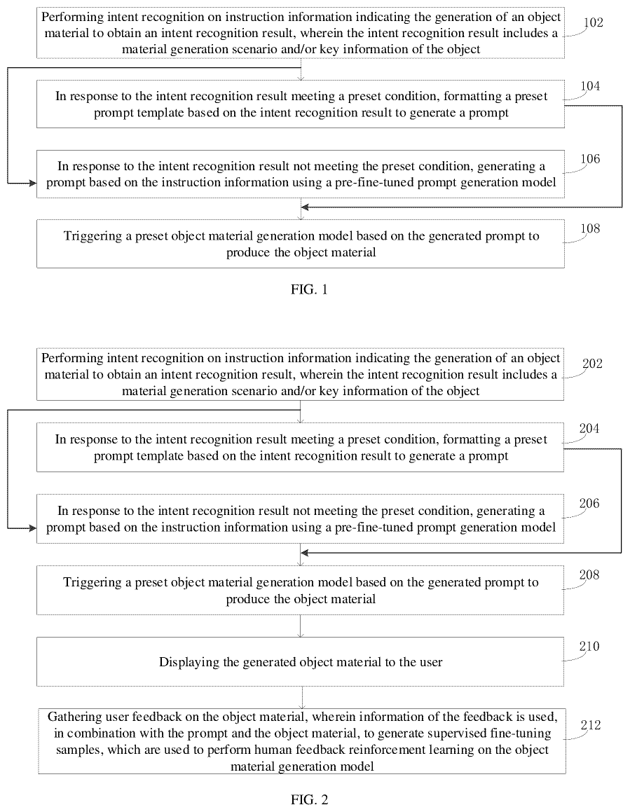

Referring to FIG. 1, in an optional embodiment, this application discloses an object material generation method that can be applied within an object material generation system. The method includes S102 to 108.

S102: performing intent recognition on instruction information used to indicate the generation of an object material to obtain an intent recognition result. The intent recognition result includes a material generation scenario and/or key information of the object.

The instruction information used to indicate the generation of object materials may be input by the user through the interface of the object material generation system. This instruction information can take various forms, such as natural language expressions, one or more keywords, a complete task description, or an example of the desired material to be generated. The instruction information may include the scenario in which the object material is needed, or it may omit this information; similarly, it may contain key information of the object or omit such details.

The material generation scenario describes the category of the task to be performed when generating object materials. In some embodiments of this application, the material generation scenarios include, but are not limited to, title generation, selling point generation, object detail generation, and marketing text generation. Specifically, the title generation scenario indicates that the instruction information is used to initiate a task for generating an object title; the selling point generation scenario indicates a task for generating selling points; the object detail generation scenario indicates a task for creating object details; and the marketing text generation scenario indicates a task for generating marketing text.

The key information of the object is used to describe essential details of the object for which material is to be generated, and this information corresponds to the material generation scenario. In some embodiments of this application, the key information of the object includes, but is not limited to, one or more of the following: the original title of the object, the object category, and object attributes. The original title of the object differs from the generated title in a title generation task. The specific content of the object category is determined according to the definitions of the e-commerce platform, including, but not limited to, categories such as clothing, footwear, videos, food, and pharmaceuticals. The attributes of objects vary by category, and their specific content is also determined according to the definitions of the e-commerce platform. This application's embodiments do not restrict the specific content of the original title, category, or attributes of the object.

In some optional embodiments, performing intent recognition on the instruction information used to indicate the generation of object materials to obtain an intent recognition result includes using a pre-fine-tuned intent recognition model to identify the material generation scenario that matches the instruction information for generating object materials and to extract the key information of the object from the instruction information.

In some optional embodiments, the intent recognition model is used to classify the user-input instruction information into preset material generation scenarios and extract key information from the user's input. During application, the input to the intent recognition model is the user's instruction information, and the output consists of two parts: the material generation scenario and the extracted key information of the object. The material generation scenarios are determined based on application requirements, and in some optional scenarios, they include, but are not limited to, one or more of the following categories: title generation, selling point generation, object detail generation, and marketing text generation. The key information of the object is also determined based on application requirements and includes, but is not limited to, categories such as the original title of the object, the object category, and object attributes. If the intent recognition model fails to extract certain key information from the instruction information, the output value for that specific category of key information can be set to null.

For example, given the instruction information, “Generate 3 selling points for an orange; this orange is from Gannan, is unwaxed, naturally ripened, and has a sweet flavor,” the intent recognition model can identify the matching material generation scenario as “selling point generation.” The extracted key information of the object would include: the original product name “orange,” product attributes such as “origin: Gannan” and “flavor: sweet,” while the product category would remain null.

For example, given the instruction information “Generate 3 selling points for an orange,” the intent recognition model can identify the matching material generation scenario as “selling point generation.” The extracted key information of the object would include the original product name “orange,” while both product attributes and product category would remain null.

In some optional embodiments, the intent recognition result may include only the material generation scenario, only the key information of the object, or both the material generation scenario and the key information of the object. The extracted key information of the object may include one or more of the original title, category, and attributes of the object, or it may exclude any specific key information. If none of the key information types are extracted from the instruction information, the value for the key information of the object can be set to null.

In some optional embodiments, the intent recognition model is a text generation model based on the BERT model architecture, which has been fine-tuned to achieve the desired functionality. Optionally, the intent recognition model is fine-tuned through the following steps: obtaining a set of first instruction information samples, wherein each first instruction information sample indicates the generation of object materials; assigning labeling information to each first instruction information sample in the set, wherein the labeling information includes the material generation scenario and the key information of the object contained in the first instruction information sample. The material generation scenarios include, but are not limited to, the following: title generation, selling point generation, object detail generation, and marketing text generation. The key information of the object includes the original title of the object, object category, and object attributes. The pre-trained generative model is then fine-tuned using input-output text pairs composed of the first instruction information samples and the corresponding labeling information to obtain the intent recognition model.

The training method for the intent recognition model is described in related embodiments below and will not be elaborated upon here.

S104: in response to the intent recognition result meeting a preset condition, formatting a preset prompt template based on the intent recognition result to generate a prompt.

After obtaining the intent recognition result corresponding to the instruction information, the next steps are determined based on the content included in the intent recognition result.

The preset conditions are used to assess whether the information contained in the intent recognition result is sufficient for the large language model to generate the object material. If sufficient, the result is considered to meet the preset conditions; otherwise, it is deemed not to meet the preset conditions.

In some optional embodiments, when the key information of the object includes the original title, category, and attributes of the object, the preset conditions include that the intent recognition result contains the material generation scenario and at least two types of the key information of the object.

Taking the previous intent recognition result as an example, for the instruction information, “Generate 3 selling points for an orange; this orange is from Gannan, is unwaxed, naturally ripened, and has a sweet flavor,” the intent recognition model identifies an intent recognition result that includes the material generation scenario “selling point generation,” along with the original product name “orange” and product attributes such as “origin: Gannan” and “flavor: sweet.” This intent recognition result includes both the material generation scenario and two types of key information for the object, which is sufficient for the large language model to generate the object material. Therefore, this intent recognition result is considered to meet the preset conditions. In contrast, if the intent recognition result for another instruction includes only one type of key information for the object, it would be deemed insufficient for the large language model to generate object material, and thus would not meet the preset conditions.

In some optional embodiments, formatting a preset prompt template based on the intent recognition result to generate a prompt includes: obtaining a pre-established prompt template corresponding to the material generation scenario; and formatting the prompt template based on the key information of the object included in the intent recognition result to generate the prompt.

The prompt template is selected from a pre-established set of prompt templates. In some optional embodiments, one or more prompt templates can be pre-established for each material generation scenario, based on the input specifications of the large language model and the application requirements for generating object materials. For example, prompt templates may be created for generating object titles, generating selling points, generating object details, and generating marketing texts. During the application phase, the material generation scenario identified from the user's instruction information is used to select the corresponding prompt template. The selected prompt template, combined with the key information of the object extracted from the instruction information, is then used to generate a prompt that aligns with both the input specifications of the large language model and the user's instructions.

Continuing with the previous example of the instruction information, “Generate 3 selling points for an orange; this orange is from Gannan, is unwaxed, naturally ripened, and has a sweet flavor,” and the corresponding intent recognition result, a prompt template for generating selling points can be selected at this step. After filling in the extracted information, a prompt is generated.

Optionally, formatting the prompt template based on the key information of the object included in the intent recognition result to generate a prompt involves replacing corresponding placeholders in the prompt template with the key information from the intent recognition result. The prompt template is designed according to the input specifications of the large language model and the required object key information for generating object materials. In this prompt template, placeholders represent the positions for key information of the object within the prompt text. During the prompt generation phase, the values of the relevant categories of object key information, extracted from the instruction information, are used to replace the placeholders for that category in the prompt template, thereby formatting the prompt template with the actual values of the key information to produce the prompt text.

The method for creating the prompt template refers to existing technology and will not be elaborated upon here.

S106: in response to the intent recognition result not meeting the preset condition, generating a prompt based on the instruction information using a pre-fine-tuned prompt generation model.

If the intent recognition result obtained in the previous steps does not contain sufficient information for the large language model to generate object material, it is necessary to first generate a prompt based on the user's instruction information using a pre-trained prompt generation model. This generated prompt is then used as the input to the large language model to produce the object material.

Optionally, if the intent recognition result does not meet the preset conditions, a prompt can be generated based on the instruction information using a pre-fine-tuned prompt generation model. This includes scenarios where the intent recognition result does not contain the material generation scenario or includes only one type of key information for the object. In such cases, the instruction information is used as the input to the pre-trained prompt generation model, which generates a prompt corresponding to the instruction information. For example, if the user inputs one or several keywords or provides a conversational description, the instruction information can first be used as input to the pre-trained prompt generation model to generate a prompt.

In some optional embodiments, the prompt generation model can be implemented using a text generation model based on LLaMA-7B. LLaMA is an autoregressive language model built on the Transformer architecture, available in various parameter sizes, with LLaMA-7B being the pre-trained version at a 7 billion parameter scale. The prompt generation model is used to generate prompts, based on the input instruction information, that meet the input requirements of the large language model.

Optionally, the prompt generation model can be fine-tuned through the following method: obtaining a set of first instruction information samples, wherein each first instruction information sample indicates the generation of object materials; using a preset question-answering language model to obtain prompts corresponding to each first instruction information sample in the set; constructing data pairs of instruction information and prompts based on each first instruction information sample and its corresponding prompt; and fine-tuning a pre-trained autoregressive language model based on these data pairs to obtain the prompt generation model.

The training method for the prompt generation model is described in related embodiments below and will not be elaborated upon here.

S108: triggering a preset object material generation model based on the generated prompt to produce the object material.

The object material generation model is obtained by fine-tuning a pre-trained large language model.

In some optional embodiments, the object material generation model can be implemented using a text generation model based on Llama2_13B. The Llama 2 series consists of large language models (LLMs) with scales ranging from 7 billion to 70 billion parameters, with the Llama2_13B model being the 13 billion parameter version in the Llama 2 series. The object material generation model is used to generate object materials based on the input prompt. The content generated by the object material generation model is determined by the input prompt; for example, the prompt can specify that the model generate an object title, selling points, object details, marketing text, and so on.

In the embodiments of the present application, after constructing the object material generation model based on the pre-trained Llama2_13B, the model is first fine-tuned using scenario-specific data where object materials need to be generated. This produces an object material generation model suitable for online generation of object materials. For example, data pairs of prompts and manually created object materials can be constructed. The object material generation model based on the pre-trained Llama2_13B is then fine-tuned using these constructed data pairs, enabling the fine-tuned model to generate object materials applicable to scenarios such as object title generation, selling point generation, object detail generation, and marketing text generation.

The object material generation model is fine-tuned through the following steps: obtaining a first prompt sample and its corresponding first object material sample; expanding the first prompt sample in a preset instruction information dimension based on the first object material sample to obtain a second prompt sample; using a preset question-answering language model to obtain a second object material sample corresponding to the second prompt sample; and fine-tuning a pre-trained large language model based on the first prompt sample and its corresponding first object material sample, as well as the second prompt sample and its corresponding second object material sample. This process yields the object material generation model.

The first prompt sample includes manually crafted prompt samples or prompt samples generated based on preset key information of the object and a preset prompt template. The first object material sample corresponding to the first prompt sample may consist of manually written object material. The preset key information of the object includes, but is not limited to, one or more of the following: the original title of the object, object category, and object attributes.

The fine-tuning method for the object material generation model is described in detail in related embodiments below and will not be elaborated upon here.

After fine-tuning the object material generation model, in the online application phase, the prompt generated by the pre-trained prompt generation model or the prompt formatted from a preset prompt template based on the intent recognition result is used as input to the object material generation model. The object material generation model then outputs object material that matches the input content.

In summary, the object material generation method disclosed in this application's embodiments performs intent recognition on instruction information that indicates the generation of object materials, extracting the key information necessary to generate object materials and obtaining an intent recognition result. Based on the specific conditions of the extracted information, a corresponding method is used to generate a prompt that conforms to the input requirements of a prompt generation model fine-tuned with scenario data. The generated prompt is then used as input to trigger the object material generation model to produce the required object material. This approach eliminates the need to fine-tune models separately for each scenario, enabling the generation of object materials for preset scenarios based on any user-input instruction information, thereby enhancing the efficiency and adaptability of object material generation.

Furthermore, when fine-tuning the object material generation model, prompt-object material data pairs for fine-tuning are enriched by automatically expanding prompts based on scenario data. This approach enables users to input any instruction information, allowing the fine-tuned object material generation model to execute content generation tasks in the e-commerce domain with greater flexibility and adaptability. Additionally, this method does not require adjusting the fine-tuning approach for the large language model each time application requirements change, resulting in more efficient object material generation.

Based on the previous embodiments, this application also discloses an object material generation method, as shown in FIG. 2, which includes Steps 202 through 212.

S202: performing intent recognition on instruction information that indicates the generation of an object material to obtain an intent recognition result. The intent recognition result includes a material generation scenario and/or key information of the object.

S204: in response to the intent recognition result meeting a preset condition, formatting a preset prompt template based on the intent recognition result to generate a prompt;

S206: in response to the intent recognition result not meeting the preset condition, generating a prompt based on the instruction information using a pre-fine-tuned prompt generation model;

S208: triggering a preset object material generation model based on the generated prompt to produce the object material;

S210: displaying the generated object material to the user;

S212: gathering user feedback on the generated object material. This feedback is used to create supervised fine-tuning samples by combining the prompt and object material, which are then used to perform human feedback reinforcement learning on the object material generation model.

The instruction information includes user-inputted instructions, and the feedback information indicates whether the generated object material matches the instruction information.

For the specific implementation of Steps 202 to 208, refer to the previous descriptions, which will not be repeated here.

In some optional embodiments, the object material generation method disclosed in this application can be implemented through an object material generation system, allowing users to input instruction information via the system's client interface. After obtaining the user's instruction information, the object material generation system executes Steps 202 to 208 to generate the corresponding object material based on the instruction information. The system then displays the generated object material to the user through the client interface.

In some optional embodiments, a feedback entry can be provided on the client side of the object material generation system to gather user feedback on the currently generated object material. For example, buttons indicating satisfaction or dissatisfaction with the generated material can be provided, and user interactions with these buttons can be detected to collect feedback on the generated object material.

The feedback information indicates whether the user is satisfied with the object material generated by the object material generation model. Therefore, user feedback can be used to iteratively optimize the model.

For example, the object material can be classified based on the feedback information: marking user-satisfied object material as Category P and user-dissatisfied object material as Category N. Then, by combining the prompt generated in Step 204 or Step 206, the object material produced by the object material generation model, and the feedback information, supervised fine-tuning samples can be created. After collecting several supervised fine-tuning samples in this manner, reinforcement learning can be applied to fine-tune the object material generation model based on these samples.

For the specific implementation of fine-tuning the object material generation model, refer to the descriptions below, which will not be repeated here.

In summary, the object material generation method disclosed in this application performs intent recognition on instruction information that indicates the generation of object materials, extracting the key information required for generating object materials to obtain an intent recognition result. Based on the specific conditions of the extracted information, a corresponding approach is used to generate a prompt that conforms to the input requirements of a prompt generation model fine-tuned with scenario data. The generated prompt then serves as input to trigger the object material generation model to produce the required object material, allowing users to control the generation of object materials for preset scenarios by inputting any instruction information. Furthermore, by gathering user feedback on the generated object material and periodically applying human feedback reinforcement learning to the object material generation model based on this feedback, the alignment between the generated object material and user requirements or application scenarios can be further enhanced.

To implement the aforementioned object material generation method, this application also discloses a model fine-tuning method. This method is used to fine-tune a pre-trained generative model based on specific scenario data as described in the embodiments of the present application, to obtain an intent recognition model.

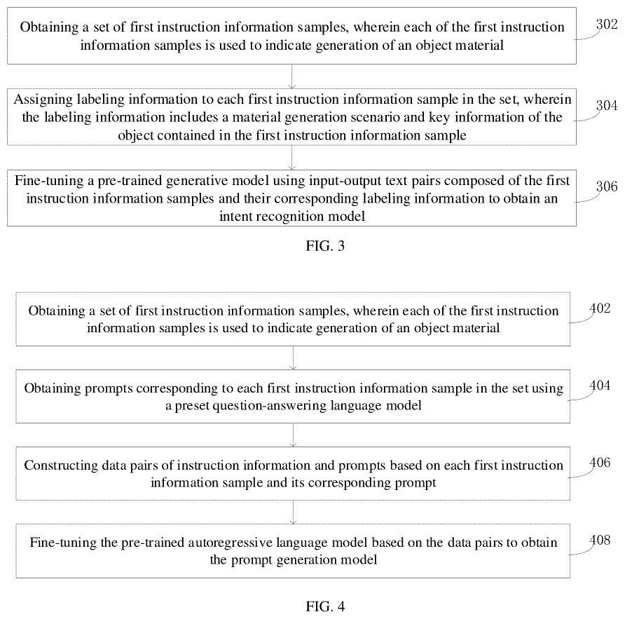

Optionally, as shown in FIG. 3, the model fine-tuning method disclosed in this application's embodiments includes S302 to 306.

S302: obtaining a set of first instruction information samples, wherein each sample is used to indicate generation of an object material;

S304: assigning labeling information to each first instruction information sample in the set. This labeling information includes a material generation scenario and key information of the object contained in the first instruction information. The material generation scenarios include, but are not limited to, the following: title generation, selling point generation, object detail generation, and marketing text generation. The key information of the object includes an original title, a object category, and an object attribute;

S306: Fine-tuning a pre-trained generative model using input-output text pairs composed of the first instruction information samples and the corresponding labeling information to obtain the intent recognition model.

In some optional embodiments, instruction information can be specifically written to generate object materials for each material generation scenario according to the needs of an e-commerce platform. In this application, these are referred to as “first instruction information samples.” For example, first instruction information samples can be created for tasks such as title generation, selling point generation, object detail generation, and marketing text generation. These first instruction information samples may include one or more types of key information of the object, such as the original title of the object, object category, or object attributes, or they may omit this key information.

Next, preset material generation scenario labels are assigned to each first instruction information sample written for a specific material generation scenario. For example, the four material generation scenarios—title generation, selling point generation, object detail generation, and marketing text generation—can be labeled with the numbers 0, 1, 2, and 3, respectively. Accordingly, the label for the first instruction information samples for the title generation task is set to 0, for the selling point generation task to 1, for the object detail generation task to 2, and for the marketing text generation task to 3.

On the other hand, for each first instruction information sample, values are assigned to the labeling information for key information of the object based on the contents of the sample, such as the original title of the object, object category, and object attributes.

Subsequently, for each first instruction information sample in the set and its corresponding labeling information, an input-output text pair is constructed by using the first instruction information sample as the input text and the corresponding labeling information as the output text. The pre-trained generative model is then fine-tuned based on these constructed input-output text pairs.

In this application of embodiments, the intent recognition model is based on the BERT text generation model architecture. During the fine-tuning phase, the pre-trained BERT model is fine-tuned using the constructed input-output text pairs to obtain the intent recognition model. As a result, the fine-tuned intent recognition model can both classify the material generation scenario matched by the input text and extract the key information of the object included in the input text.

For the specific implementation of fine-tuning the pre-trained BERT model based on the constructed input-output text pairs to obtain the intent recognition model, refer to existing technology. This aspect will not be elaborated further in the embodiments of the present application.

In summary, the model fine-tuning method disclosed in this application's embodiments involves obtaining a set of first instruction information samples, wherein each sample is used to indicate the generation of object materials. Each first instruction information sample in the set is then assigned labeling information, which includes the material generation scenario and key information of the object contained in the sample. The material generation scenarios include, but are not limited to, title generation, selling point generation, object detail generation, and marketing text generation. The key information of the object includes the original title, category, and attributes of the object. Subsequently, the pre-trained generative model is fine-tuned using input-output text pairs, composed of the first instruction information samples and their corresponding labeling information, to obtain an intent recognition model. This fine-tuned intent recognition model is thus equipped to recognize the preset material generation scenario matched by the instruction information and to extract key information of the object from the input instruction information.

To implement the aforementioned object material generation method, this application also discloses a model fine-tuning method. This method fine-tunes a pre-trained generative model based on user instruction information and prompt text in the e-commerce scenario as described in this application's embodiments, to obtain a prompt generation model.

Optionally, as shown in FIG. 4, the model fine-tuning method disclosed in this application's embodiments includes S402 to 408.

S402: Obtaining a set of first instruction information samples, wherein each sample is used to indicate generation of an object material;

S404: obtaining prompts corresponding to each first instruction information sample in the set using a preset question-answering language model;

S406: constructing data pairs of instruction information and prompts based on each first instruction information sample and its corresponding prompt;

S408: Fine-tuning the pre-trained autoregressive language model based on the data pairs to obtain the prompt generation model.

Optionally, the preset question-answering language model can be the GPT-4 model (i.e., the fourth-generation generative pre-trained model). GPT-4 is the latest AI language model released by OpenAI and is the fourth version of the GPT model series. The first instruction information samples may include manually written instruction information.

During the fine-tuning process for the prompt generation model, the first instruction information sample serves as the initial draft of the prompt. The output from the GPT-4 model, refined and filtered by human review, is used as the optimized prompt. Fine-tuning is then performed on the autoregressive language model based on the initial draft and optimized prompt, resulting in a prompt generation model capable of optimizing prompts based on any user-input instruction information to meet the requirements of subsequent steps.

In summary, the model fine-tuning method disclosed in this application's embodiments involves obtaining manually written first instruction information samples to comprehensively sample user input instructions. Then, a preset question-answering language model is used to generate prompts corresponding to each first instruction information sample. A fine-tuning dataset is created based on these samples and prompts, which significantly improves the efficiency of obtaining fine-tuning samples and facilitates the generation of a large volume of fine-tuning samples. This approach enhances the prompt generation model's ability to generate optimized prompts based on any user input information.

To implement the aforementioned object material generation method, this application also discloses a model fine-tuning method. This method fine-tunes a pre-trained large language model based on prompts and object materials within the e-commerce scenario as described in this application's embodiments, to obtain an object material generation model.

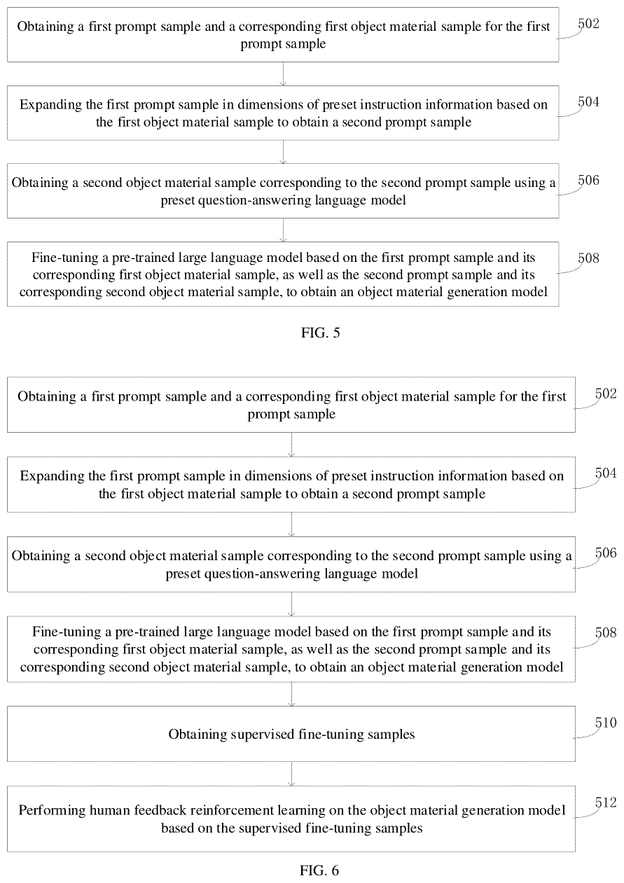

Optionally, as shown in FIG. 5, the model fine-tuning method disclosed in this application's embodiments includes S502 to 508.

S502: obtaining a first prompt sample and a corresponding first object material sample for the first prompt sample;

S504: expanding the first prompt sample in dimensions of preset instruction information based on the first object material sample to obtain a second prompt sample;

S506: obtaining a second object material sample corresponding to the second prompt sample using a preset question-answering language model;

S508: fine-tuning the pre-trained large language model based on the first prompt sample and its corresponding first object material sample, as well as the second prompt sample and its corresponding second object material sample, to obtain an object material generation model.

The first prompt sample includes manually written prompt samples or prompt samples generated based on preset key information of the object and a preset prompt template. The corresponding first object material sample for the first prompt sample may be manually written object material. The preset key information of the object includes, but is not limited to, one or more of the following: the original title of the object, object category, and object attributes.

For example, the first prompt sample can be generated as follows: obtaining the preset key information of an object on an e-commerce platform, and using this key information to format a prompt template corresponding to a preset material generation scenario, to obtain the first prompt sample. The preset material generation scenarios include, but are not limited to, one or more of the following: object title generation, selling point generation, object detail generation, and marketing text generation.

Optionally, the preset instruction information dimensions may include one or more of the following: target language for generation, number of languages generated per request, number of content items generated per request, character length of the generated content, and the position of key information within the generated content.

In the embodiments of the present application, fine-tuning the object material generation model involves two stages. The first stage fine-tunes the pre-trained Llama2_13B model to obtain the object material generation model, and the second stage optimizes the model based on user feedback on the generated object material.

From the application scenarios of the object material generation method, it is evident that there are two sources of prompts input to the object material generation model: one generated based on key information of the object extracted from user input and a preset prompt template, and the other generated by a pre-trained prompt generation model. Therefore, it is necessary to construct samples for both types of prompts to fine-tune the pre-trained Llama2_13B model in the first stage.

In some optional embodiments, the first prompt samples can be generated by collecting information such as the original title, category, and attributes of objects on an e-commerce platform and populating this information into preset prompt templates tailored for different object material generation tasks. In this application, these are referred to as “first prompt samples.” In other optional embodiments, first prompt samples may also be manually written by professionals. For each first prompt sample, the corresponding object material can either be manually written or obtained using a preset question-answering language model from existing technology. This corresponding material is referred to as the “first object material sample.”

To ensure that object material generation adapts to any prompt format, the prompt generation model must be capable of producing high-quality object material from any user input, including prompts generated by a pre-fine-tuned prompt generation model. This requires a diverse dataset of prompt and object material samples. Based on potential instructions in the e-commerce domain, it has been determined that the prompt generation model should support at least the following instructions: control over the language(s) in which object material is generated and the number of languages per generation, control over the number of content items generated in a single request (e.g., generating multiple titles at once), control over the character length of the generated content (e.g., long or short titles, long or short selling points), and emphasis on key information within the generated content.

In the embodiments of the present application, the first prompt samples and first object material samples are fully utilized to enrich prompt diversity. By adjusting requirements in these samples, a second set of prompt samples is generated. For example, if the first prompt sample specifies content in English, the language keyword can be modified to generate content in Spanish, French, Portuguese, Korean, or another language, to obtain a second prompt sample. Similarly, if the first prompt sample requests a single product title, the keyword can be adjusted to specify generating 3 to 5 product titles, creating another second prompt sample. Likewise, if the initial prompt specifies generating one selling point, the number can be modified to request 5 to 10 selling points. Additionally, if the first prompt sample specifies a title length of 20 to 30 words, this can be adjusted to a length of 50 to 100 words. Through these prompt expansion methods, multiple second prompt samples can be generated with varied instructions.

Next, a preset question-answering language model (such as GPT-4) is used to generate corresponding second object material samples based on the second prompt samples, forming multiple data pairs. This process enables the construction of a dataset that addresses various distinct requirements, significantly enriching the dataset's content.

Subsequently, existing model fine-tuning techniques can be used to fine-tune the pre-trained large language model based on the first prompt samples and their corresponding first object material samples, as well as the second prompt samples and their corresponding second object material samples. This process results in the object material generation model.

In summary, the model fine-tuning method disclosed in this application's embodiments involves obtaining first prompt samples and their corresponding first object material samples. These first prompt samples are then expanded based on preset instruction dimensions derived from the first object material samples to create second prompt samples. Next, a preset question-answering language model generates second object material samples corresponding to the second prompt samples, resulting in a dataset covering various requirements and significantly enriching the fine-tuning dataset. The expanded dataset is then used to fine-tune a pre-trained large language model, to obtain an object material generation model. This approach effectively enhances algorithm iteration efficiency and improves the usability of the object material generation model, enabling the fine-tuned model to generate object materials based on any instruction. Testing has shown that the object material generation model fine-tuned with this method can accurately produce e-commerce object materials even from conversational or informal instruction information.

For instance, in an e-commerce context, cross-border platforms need to display product names, descriptions, and other details to users across different countries and regions. This requires generating product materials in multiple languages. Manually creating multilingual product materials is both labor-intensive and inefficient. Current text generation methods, which are generally trained on English data, lack the ability to produce materials in multiple languages. Using the model fine-tuning method disclosed in this application, we first gather prompt samples intended for generating English product materials (referred to as “first prompt samples”) along with corresponding English product material samples (i.e., “first object material samples”). Then, by modifying the language keyword in the English prompt samples to the desired target language, we create prompt samples for generating product materials in that target language (termed “second prompt samples”). The target language can be any non-English language, such as Spanish, French, Portuguese, or Korean. Subsequently, a preset question-answering language model is used to generate product materials in each target language based on these prompt samples, to obtain product material samples for each target language (i.e., “second object material samples”). Finally, we combine the English prompt samples and their corresponding English product material samples with the prompt and product material samples in each non-English language (e.g., Spanish, French, Portuguese, Korean) to form a comprehensive fine-tuning dataset. This dataset is then used to fine-tune the pre-trained large language model, thereby creating the object material generation model. This fine-tuned large language model, leveraging the enriched multilingual dataset, is capable of generating product materials in the respective language based on prompts in English or any specified target language, thus enabling the generation of product materials according to instructions in a wide range of languages.

In some optional embodiments, and with reference to FIG. 6, after fine-tuning the pre-trained large language model to obtain the object material generation model, the method further includes S510 and S512.

S510: obtaining supervised fine-tuning samples, which include a third prompt sample, a corresponding third object material sample, and a sample category that matches the third object material sample. The sample category is determined based on user feedback regarding the third object material sample.

S512: performing human feedback reinforcement learning on the object material generation model based on the supervised fine-tuning samples.

After the object material generation model is deployed, as more object materials are generated based on user-provided instruction information, a substantial amount of user feedback can be collected to assess whether the generated object materials meet quality standards. In the embodiments of the present application, supervised fine-tuning samples can be constructed based on user feedback. These supervised fine-tuning samples include: the prompt, the object material generated by the model based on the prompt, and the feedback result indicating whether the object material is satisfactory. The model then undergoes human feedback reinforcement learning based on these supervised fine-tuning samples.

For the specific implementation of performing human feedback reinforcement learning on the object material generation model based on the supervised fine-tuning samples, refer to the description in Step 139, as well as existing technologies, which will not be elaborated upon here.

By collecting user feedback on the generated object materials and periodically applying human feedback reinforcement learning to the object material generation model based on this feedback, the alignment between the generated object materials and user requirements or specific application scenarios can be further improved.

Based on the above embodiments, this application also discloses an object material generation system designed to implement the aforementioned object material generation method. The object material generation system includes a client and a server, where:
the client is configured to obtain instruction information input by the user that indicates the generation of object materials and to send this instruction information to the server;
the server is configured to perform intent recognition on the instruction information to obtain an intent recognition result, wherein the intent recognition result includes a material generation scenario and/or key information of the object;
the server is further configured to, if the intent recognition result meets preset conditions, format a preset prompt template based on the intent recognition result to generate a prompt; or,
the server is also configured to, if the intent recognition result does not meet the preset conditions, generate a prompt based on the instruction information using a pre-fine-tuned prompt generation model.

The server is further configured to trigger a preset object material generation model based on the generated prompt to produce the object material and send the object material to the client;
the client is also configured to display the generated object material to the user.

In some optional embodiments, the client is also configured to gather user feedback on the object material and send this feedback information to the server;
the server is further configured to use the feedback information, along with the prompt and the object material, to generate supervised fine-tuning samples. These supervised fine-tuning samples are used to perform human feedback reinforcement learning on the object material generation model.

The specific implementation of the above steps executed by the server can be referenced in the descriptions of the relevant steps in the method embodiments provided earlier, and will not be elaborated upon here.

In summary, the object material generation system disclosed in this application performs intent recognition on instruction information that indicates the generation of object materials, extracting the key information necessary for generating the materials to obtain an intent recognition result. Based on the specific conditions of the extracted information, the system generates a prompt suitable for input to a prompt generation model fine-tuned with scenario data. This prompt is then used as input to trigger the object material generation model to produce the required object material. This approach eliminates the need for separate fine-tuning of models for each scenario, allowing for the generation of object materials for preset scenarios based on any user-input instruction, thereby enhancing the efficiency and adaptability of object material generation.

It should be noted that, for simplicity of description, the method embodiments are presented as a series of combined actions. However, those skilled in the art will understand that the embodiments of the present application are not limited by the sequence of actions described, as some steps may be performed in a different order or simultaneously, depending on the embodiments. Furthermore, it should be understood by those skilled in the art that the embodiments described in the specification are preferred embodiments, and the actions involved are not necessarily essential to the embodiments of the present application.

Based on the above embodiments, this embodiment also provides an object material generation device, which includes:
an intent recognition module, configured to perform intent recognition on instruction information indicating the generation of object materials, yielding an intent recognition result. The intent recognition result includes a material generation scenario and/or key information of the object;
a first prompt generation module, configured to generate a prompt by formatting a preset prompt template based on the intent recognition result, if the intent recognition result meets preset conditions;
a second prompt generation module, configured to generate a prompt based on the instruction information using a pre-fine-tuned prompt generation model, if the intent recognition result does not meet the preset conditions;
an object material generation module, configured to trigger a preset object material generation model based on the generated prompt to produce the object material.

In some optional embodiments, the key information of the object includes the original title, category, and attributes of the object, and the preset conditions include:
the intent recognition result contains the material generation scenario and at least two types of key information of the object.

In some optional embodiments, formatting a preset prompt template based on the intent recognition result to generate a prompt includes:
obtaining a pre-established prompt template corresponding to the material generation scenario;
formatting the prompt template based on the key information of the object included in the intent recognition result to generate the prompt.

In some optional embodiments, the intent recognition module is further configured to:
using a pre-fine-tuned intent recognition model to identify the material generation scenario matched by the instruction information for generating object materials, and extract key information of the object from the instruction information.

In some optional embodiments, the instruction information includes user-inputted instructions. After the preset object material generation model is triggered by the generated prompt to produce object material, the device further includes:
an object material display module, configured to present the generated object material to the user;
a feedback information acquisition module, configured to gather user feedback on the object material. This feedback information is used, along with the prompt and the object material, to generate supervised fine-tuning samples, which are employed to perform human feedback reinforcement learning on the object material generation model.

In summary, the object material generation device disclosed in this application's embodiments performs intent recognition on instruction information that indicates the generation of object materials, extracting the key information needed to produce the materials and obtaining an intent recognition result. Based on the specifics of the extracted information, the device generates a prompt compatible with a prompt generation model fine-tuned with scenario data. This prompt then serves as input to trigger the object material generation model to produce the required object material. By not requiring separate fine-tuning for each scenario, this approach enables the generation of object materials for preset scenarios based on any user-provided instruction information, thereby improving the efficiency and adaptability of object material generation.

Based on the above embodiments, this embodiment further provides a model fine-tuning device, which includes:
a sample set acquisition module, configured to obtain a set of first instruction information samples, wherein each first instruction information sample is used to indicate the generation of object materials;
a sample labeling module, configured to assign labeling information to each first instruction information sample in the set. This labeling information includes the material generation scenario and the key information of the object contained in the first instruction information sample. The material generation scenarios include any of the following: title generation, selling point generation, object detail generation, and marketing text generation. The key information of the object includes the original title of the object, object category, and object attributes.

A model fine-tuning module, configured to fine-tune a pre-trained generative model using input-output text pairs composed of the first instruction information samples and their corresponding labeling information to obtain an intent recognition model.

In summary, the model fine-tuning device disclosed in this application's embodiments operates by obtaining a set of first instruction information samples, each of which indicates the generation of object materials. It assigns labeling information to each sample in the set, including the material generation scenario and key information of the object contained in the first instruction information sample. The material generation scenarios may include any of the following: title generation, selling point generation, object detail generation, and marketing text generation. The key information of the object may include the original title of the object, object category, and object attributes. The device then uses input-output text pairs, composed of the first instruction information samples and their corresponding labeling information, to fine-tune a pre-trained generative model, to obtain an intent recognition model. This fine-tuned intent recognition model is thus equipped to recognize the preset material generation scenario matched by the instruction information and to extract key information of the object from the input instruction information.

Building on the previous embodiments, this embodiment further provides a model fine-tuning device, which includes:
a first sample set acquisition module, configured to obtain a first prompt sample and the corresponding first object material sample.

A second sample set acquisition module, configured to expand the first prompt sample along preset instruction dimensions based on the first object material sample to generate a second prompt sample;
the second sample set acquisition module is also configured to use a preset question-answering language model to obtain a second object material sample corresponding to the second prompt sample;
a model fine-tuning module, configured to fine-tune a pre-trained large language model based on the first prompt sample and its corresponding first object material sample, as well as the second prompt sample and its corresponding second object material sample, to obtain the object material generation model.

In some optional embodiments, the preset instruction dimensions may include one or more of the following: target generation language, number of languages generated per request, number of content items generated per request, character length of the generated content, and the position of key information within the generated content.

In some optional embodiments, after fine-tuning the pre-trained large language model to obtain the object material generation model, the device further includes:
a supervised fine-tuning module, configured to obtain supervised fine-tuning samples. These supervised fine-tuning samples include a third prompt sample, the corresponding third object material sample, and the sample category matching the third object material sample. The sample category is determined based on user feedback regarding the third object material sample.

The supervised fine-tuning module is also configured to perform human feedback reinforcement learning on the object material generation model based on the supervised fine-tuning samples.

In summary, the model fine-tuning device disclosed in this application's embodiments operates by obtaining a first prompt sample and its corresponding first object material sample. Based on this first object material sample, the first prompt sample is expanded along preset instruction dimensions to produce a second prompt sample. Then, a preset question-answering language model generates a second object material sample corresponding to the second prompt sample, thereby creating a dataset that addresses various requirements and significantly enriches the fine-tuning dataset. This expanded dataset is subsequently used to fine-tune a pre-trained large language model, to obtain the object material generation model. This approach enhances the efficiency of algorithm iterations and the usability of the model, enabling the fine-tuned object material generation model to produce object materials based on any instruction. Testing has shown that the model fine-tuned with this method is capable of accurately generating e-commerce object materials even from conversational or informal instruction information.

Furthermore, by collecting user feedback on the generated object materials and periodically applying human feedback reinforcement learning to the object material generation model based on this feedback, the alignment between the model-generated object materials and user needs or specific application scenarios can be further improved.

Embodiments of the present application also provides a non-volatile readable storage medium that stores one or more modules (programs). When applied in a device, these modules enable the device to execute the instructions for each method step described in the embodiments of the present application.

Embodiments of the present application also provides a computer-readable storage medium storing computer-executable instructions. When executed by a processor, these instructions implement the methods described in the embodiments of the present application.

Embodiments of the present application also provide an electronic device, which includes a processor and a memory communicatively connected to the processor. The memory stores computer-executable instructions, and the processor executes these instructions to implement the methods described in the embodiments of the present application. In these embodiments, the electronic device may include servers, terminal devices, and similar equipment.

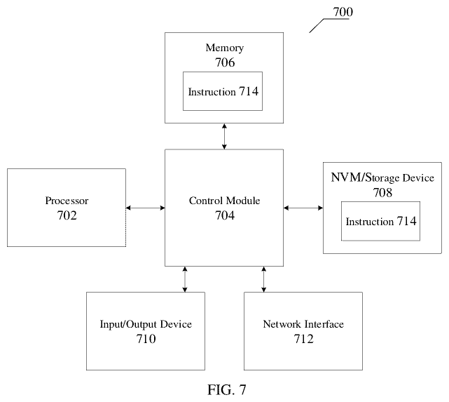

The embodiments disclosed herein may be implemented using any suitable combination of hardware, firmware, software, or any combination thereof to achieve the desired configuration. Such a device may include electronic equipment such as servers (or server clusters), terminals, and other electronic devices. FIG. 7 schematically illustrates an exemplary device 700 that may be used to implement the embodiments described in this application.

In one embodiment, FIG. 7 illustrates an exemplary device 700, which includes one or more processors 702, a control module (chipset) 704 coupled to at least one of the processors 702, memory 706 coupled to the control module 704, non-volatile memory (NVM)/storage device 708 coupled to the control module 704, one or more input/output devices 710 coupled to the control module 704, and a network interface 712 also coupled to the control module 704.

The processor 702 may include one or more single-core or multi-core processors and can comprise any combination of general-purpose or specialized processors (e.g., graphics processors, application processors, baseband processors, etc.). In some embodiments, the device 700 can function as the server, terminal, or other equipment described in the embodiments of the present application.

In some embodiments, the device 700 may include one or more computer-readable media (such as memory 706 or NVM/storage device 708) that contain instructions 714. These media are combined with one or more processors 702 configured to execute the instructions 714, thereby implementing modules to perform the actions described in this disclosure.

In one embodiment, the control module 704 may include any suitable interface controller to provide an interface for at least one of the processors 702 and/or any appropriate devices or components communicating with the control module 704.

The control module 704 may include a memory controller module to provide an interface to memory 706. The memory controller module can be implemented as a hardware module, software module, and/or firmware module.

The memory 706 can be used, for example, to load and store data and/or instructions 714 for the device 700. In one embodiment, the memory 706 may include any suitable volatile memory, such as DRAM. In some embodiments, the memory 706 may include Double Data Rate Type 4 Synchronous Dynamic Random Access Memory (DDR4 SDRAM).

In one embodiment, the control module 704 may include one or more input/output controllers to provide an interface to the NVM/storage device 708 and the input/output device(s) 710.

For example, the NVM/storage device 708 may be used to store data and/or instructions 714. The NVM/storage device 708 may include any suitable non-volatile memory (e.g., flash memory) and/or any suitable non-volatile storage device(s) (such as one or more hard disk drives (HDDs), one or more compact disc (CD) drives, and/or one or more digital versatile disc (DVD) drives).

The NVM/storage device 708 may include storage resources that are part of the device 700 on which it is installed, or it may be accessible to the device without necessarily being part of it. For example, the NVM/storage device 708 may be accessed via a network through one or more input/output devices 710.

(One or more) input/output devices 710 may provide the device 700 with an interface for communication with any other suitable devices. The input/output devices 710 may include communication components, audio components, sensor components, and so on. The network interface 712 provides the device 700 with an interface for communication over one or more networks. Device 700 may wirelessly communicate with components of a wireless network according to any one or more wireless network standards and/or protocols, such as Bluetooth, WiFi, 2G, 3G, 4G, 5G, or a combination thereof.

In one embodiment, at least one of the processors 702 may be logically packaged with one or more controllers of the control module 704 (e.g., a memory controller module). In another embodiment, at least one of the processors 702 may be logically packaged with one or more controllers of the control module 704 to form a System-in-Package (SiP). In yet another embodiment, at least one of the processors 702 may be logically integrated with one or more controllers of the control module 704 on the same die. In another embodiment, at least one of the processors 702 and one or more controllers of the control module 704 may be integrated on the same die to form a System-on-Chip (SoC).

In various embodiments, the device 700 may be, but is not limited to, a server, a desktop computing device, or a mobile computing device (such as a laptop, handheld computing device, tablet, netbook, etc.), as well as other terminal devices. In some embodiments, the device 700 may have more or fewer components and/or a different architecture. For example, in certain embodiments, the device 700 may include one or more cameras, a keyboard, an LCD screen (including a touchscreen display), non-volatile memory ports, multiple antennas, a graphics chip, an application-specific integrated circuit (ASIC), and speakers.

In this setup, the main control chip can be used as the processor or control module within the detection device. Sensor data, location information, and other relevant information can be stored in memory or in the NVM/storage device. The sensor array can function as the input/output device, and the communication interface may include the network interface.

Embodiments of the present application also provide an electronic device, which includes a processor and a memory storing executable code. When this code is executed, it enables the processor to perform one or more of the methods described in the embodiments of the present application. In this embodiment, the memory can store various types of data, such as target files, data associated with files and applications, and user behavior data, providing a data foundation for various processing tasks.

Embodiments of the present application also provide one or more machine-readable media storing executable code. When this code is executed, it enables the processor to perform one or more of the methods described in the embodiments of the present application.

For the device embodiments, the descriptions are relatively brief due to their similarity to the method embodiments. For details, please refer to the relevant portions of the method embodiments.

Each embodiment in this specification is described progressively, with each embodiment highlighting its differences from others. For similar or identical parts across embodiments, please refer to the relevant sections as needed.

Embodiments of the present application are described with reference to flowcharts and/or block diagrams of methods, terminal devices (systems), and computer program products in accordance with the embodiments of the present application. It should be understood that each process and/or block in the flowcharts and/or block diagrams, as well as the combination of processes and/or blocks, can be implemented by computer program instructions. These computer program instructions can be provided to a general-purpose computer, a specialized computer, an embedded processor, or other programmable data processing terminal devices to create a machine, such that the instructions executed by the processor of the computer or other programmable data processing terminal device generate an apparatus for implementing the functions specified in one or more processes in the flowcharts or one or more blocks in the block diagrams.

These computer program instructions may also be stored in a computer-readable storage medium that directs a computer or other programmable data processing terminal device to operate in a specific manner. The instructions stored in the computer-readable storage medium create an article of manufacture that includes instruction means, which implement the functions specified in one or more processes of the flowcharts and/or one or more blocks in the block diagrams.

These computer program instructions can also be loaded onto a computer or other programmable data processing terminal device, causing the computer or device to execute a series of operational steps to produce computer-implemented processing. As a result, the instructions executed on the computer or other programmable terminal device provide steps for implementing the functions specified in one or more processes in the flowcharts and/or one or more blocks in the block diagrams.

While preferred embodiments of this application have been described, those skilled in the art, once aware of the basic inventive concept, may make further changes and modifications to these embodiments. Therefore, the appended claims are intended to be construed to include the preferred embodiments as well as all changes and modifications that fall within the scope of this application's embodiments.

Finally, it should be noted that relational terms such as “first” and “second” are used merely to distinguish one entity or operation from another and do not necessarily imply any actual relationship or order between such entities or operations. Furthermore, the terms “include,” “comprise,” or any of their variants are intended to cover non-exclusive inclusion, so that a process, method, article, or terminal device that includes a set of elements is not limited to those elements, but may also include other elements not explicitly listed, or elements inherent to such process, method, article, or terminal device. In the absence of further limitations, an element defined by the phrase “comprising a . . . ” does not exclude the presence of additional identical elements in the process, method, article, or terminal device that includes the element.

The above provides a detailed description of an object material generation method, an object material generation system, a model fine-tuning method, an electronic device, and a storage medium as disclosed in this application. Specific examples have been applied to explain the principles and implementation methods of this application. The descriptions of these embodiments are intended solely to aid in understanding the methods and core ideas of this application. Additionally, general technical personnel in the field may make modifications in specific implementations and application scopes based on the concepts of this application. In summary, the content of this specification should not be construed as limiting the scope of this application.

What is claimed is:

1. An object material generation method, comprising:
performing intent recognition on instruction information indicating the generation of an object material to obtain an intent recognition result, wherein the intent recognition result includes a material generation scenario and/or key information of the object;
in response to the intent recognition result meeting a preset condition, formatting a preset prompt template based on the intent recognition result to generate a prompt;
in response to the intent recognition result not meeting the preset condition, generating a prompt based on the instruction information using a pre-fine-tuned prompt generation model;
triggering a preset object material generation model based on the generated prompt to produce the object material.

2. The method according to claim 1, wherein the key information of the object comprises an original title of the object, an object category, and object attributes, and the preset condition comprises:
the intent recognition result including the material generation scenario and at least two types of the key information of the object.

3. The method according to claim 1, wherein formatting a preset prompt template based on the intent recognition result to generate a prompt comprises:
retrieving a pre-established prompt template corresponding to the material generation scenario; and
formatting the prompt template based on the key information of the object included in the intent recognition result to generate the prompt.

4. The method according to claim 1, wherein performing intent recognition on the instruction information indicating the generation of an object material to obtain an intent recognition result comprises:
identifying the material generation scenario matched by the instruction information for generating the object material using a pre-fine-tuned intent recognition model; and extracting the key information of the object from the instruction information.

5. The method according to claim 1, wherein the instruction information comprises user-inputted instruction information, and after triggering a preset object material generation model based on the generated prompt to produce the object material, the method further comprises:
displaying the generated object material to the user; and
gathering user feedback on the generated object material, wherein information of the feedback is used, in combination with the prompt and the object material, to generate supervised fine-tuning samples, which are used to perform human feedback reinforcement learning on the object material generation model.

6. A non-transitory computer-readable storage medium configured with instructions executable by one or more processors to cause the one or more processors to perform the method of claim 1.

7. An electronic device comprising:
one or more processors; and
one or more computer-readable memories coupled to the one or more processors and having instructions stored thereon that are executable by the one or more processors to perform the method of claim 1.

8. A model fine-tuning method, comprising:
obtaining a set of first instruction information samples, wherein each of the first instruction information samples is used to indicate generation of an object material;
assigning labeling information to each first instruction information sample in the set, wherein the labeling information includes a material generation scenario and key information of the object contained in the first instruction information sample, and wherein the material generation scenario includes any of the following: title generation, selling point generation, object detail generation, and marketing text generation, and the key information of the object includes an original title of the object, an object category, and an object attribute;
fine-tuning a pre-trained generative model using input-output text pairs composed of the first instruction information samples and their corresponding labeling information to obtain an intent recognition model.

9. A non-transitory computer-readable storage medium configured with instructions executable by one or more processors to cause the one or more processors to perform the method of claim 8.

10. An electronic device comprising:
one or more processors; and
one or more computer-readable memories coupled to the one or more processors and having instructions stored thereon that are executable by the one or more processors to perform the method of claim 8.

11. A model fine-tuning method, comprising:
obtaining a first prompt sample and a corresponding first object material sample for the first prompt sample;
expanding the first prompt sample in dimensions of preset instruction information based on the first object material sample to obtain a second prompt sample;
obtaining a second object material sample corresponding to the second prompt sample using a preset question-answering language model;
fine-tuning a pre-trained large language model based on the first prompt sample and its corresponding first object material sample, as well as the second prompt sample and its corresponding second object material sample, to obtain an object material generation model.

12. The method according to claim 11, wherein the dimensions of preset instruction include one or more of the following dimensions: target generation language, number of languages generated per request, number of content items generated per request, character length of the generated content, and position of key information within the generated content.

13. The method according to claim 11, further comprising, after fine-tuning the pre-trained large language model to obtain the object material generation model:
obtaining supervised fine-tuning samples, wherein the supervised fine-tuning samples include a third prompt sample, a corresponding third object material sample, and a sample category that matches the third object material sample, wherein the sample category is determined based on user feedback regarding the third object material sample;
performing human feedback reinforcement learning on the object material generation model based on the supervised fine-tuning samples.

14. A non-transitory computer-readable storage medium configured with instructions executable by one or more processors to cause the one or more processors to perform the method of claim 11.

15. An electronic device comprising:
one or more processors; and
one or more computer-readable memories coupled to the one or more processors and having instructions stored thereon that are executable by the one or more processors to perform the method of claim 11.
